(19) United States
(12) Patent Application Publication
(10) Pub. No.: US 2023/0036929 A1
(43) Pub. Date: Feb. 2, 2023

(54) DEVICE FOR PACKAGING AND DISPENSING A COSMETIC PRODUCT

(71) Applicant: L'OREAL, Paris (FR)

(72) Inventor: Maxim STIMPFLING, Clichy (FR)

(73) Assignee: L'OREAL, Paris (FR)

(21) Appl. No.: 17/789,686

(22) PCT Filed: Dec. 17, 2020
(86) PCT No.: PCT/EP2020/086639

§ 371 Date: Jun. 28, 2022

(30) Foreign Application Priority Data
Jan. 7, 2020 (FR) 2000081

(51) Int. Cl. A45D 34/04; B32B 27/08; B32B 27/10; B32B 27/32; B32B 29/08; A47K 5/122

(52) U.S. Cl. CPC A45D 34/04; B32B 27/08; B32B 27/10; B32B 27/32; B32B 29/08; A47K 5/122; B32B 2307/728

(57) ABSTRACT

The present application relates to a packaging and dispensing assembly comprising a substantially tubular body obtained from a multilayer complex material, at least one inner layer of which is made from a hydrophilic material, said tubular body having at least one longitudinal end closed by a flat joint between two opposite portions of said tubular body and at which the multilayer material has a free edge directly exposing said layer of hydrophilic material, the assembly being characterized in that the free edges of the flat joint are covered with a strip of an impermeable material extending on both sides of said flat joint, said strip of impermeable material being fixed in an at least watertight manner to the tubular body along the flat joint.

The present invention relates to a device for packaging and dispensing cosmetic products. More particularly, the device is of the compressible deformable tube (or “squeeze tube”) type.

A “cosmetic product” is understood to be any product as defined in Regulation (EC) No 1223/2009 of the European Parliament and of the Council of Nov. 30, 2009 on cosmetic products. The present application is more specifically intended for body hygiene cosmetic products that are used in particularly humid environments, such as soaps, shower gels, shampoos and toothpastes.

Generally, such a compressible tube comprises a tubular body made of a flexible material having a first, open end equipped with a dispensing head, and a second, closed end. The assembly defines an internal volume intended to contain the cosmetic product. The dispensing head conventionally has a neck on which a cap is fixed. The second end is generally closed after filling with the cosmetic product, by said tubular partition being pinched and the pinched-together opposite portions being welded or bonded.

The tubular body may be made from numerous types of material. In particular, it is possible to produce this body by extruding a plastics material (polyethylene, polypropylene for example) directly in the form of a tube, portions of which are cut off at the desired length. A first end of the portion is equipped with the dispensing head while the second end is left open for filling the tube with the cosmetic product. After filling, the tube is closed by the second end being pinched and the portions thus pinched together being welded or bonded.

The tubular body may also be produced from a sheet or strip of material wound on itself so as to form said tube, a first longitudinal end of the strip of material then being joined, by bonding or welding for example, to an opposite longitudinal edge of said strip of flexible material. Once the tube has been formed, a first end is equipped with the dispensing head while the second, opposite end is closed by pinching and welding after filling. The documents EP1679265A1, U.S. Pat. No. 4,123,312A and WO2013088416A1 describe such methods for manufacturing compressible tubes.

Depending on the kind of cosmetic product contained in the compressible tube, it may be desirable to use specific materials that have, for example, an oxygen barrier function. These materials having specific functionalities are frequently used within a multilayer complex material. Thus, multilayer materials are known that comprise an aluminum foil disposed within internal and external layers made of plastics materials. Such a tube is described for example in the document FR2984092A1.

In order to limit the amount of plastics materials used, cardboard-based multilayer complex materials have been known for many years. Such materials are sold in particular by the company Tetrapak® and are frequently used to package food products in the form of brick packs. The use of cardboard has many advantages, in particular in terms of weight, cost, flexibility and recyclability. The layer(s) of cardboard are protected from the outside and from the liquid contained in the brick pack by impermeable polyethylene layers.

However, as soon as such a material is cut, it has edges at which the (cellulose) cardboard layer is exposed. In a humid environment, the latter is then capable of absorbing water and thus swelling and deforming, thereby risking the integrity of the material being impaired over time.

On account of the presence of these highly hydrophilic cellulose layers, this type of material is difficult to use and to store in environments with a high humidity level, limiting their use for bathroom products for example, and in particular for body hygiene products intended to be used in the shower.

In the particular case of a compressible tube, it should be noted that the sheet of material is in particular cut at the second end, known as the filling end, which is closed by pinching and welding. Thus, swelling and deformation of the material could compromise the integrity of the closure of the tube, this clearly not being desirable.

This is one reason for which this type of material is used little for such body hygiene products, and in particular in the form of a compressible tube. There is therefore a need for a solution that makes it possible to improve the compatibility of this type of packaging with use and storage in very humid environments.

To this end, the present invention provides a packaging and dispensing assembly comprising a substantially tubular body obtained from a multilayer complex material, at least one inner layer of which is made from a hydrophilic material. The tubular body has at least one longitudinal end closed by a flat joint between two opposite portions of said tubular body and at which the multilayer material has a free edge directly exposing said layer of hydrophilic material.

According to the present application, the free edges of the flat joint are covered with a strip of an impermeable material extending on both sides of said flat joint, said strip of impermeable material being fixed in an at least watertight manner to the tubular body along the flat joint.

Thus, by providing the attachment of a strip of impermeable material, that is to say one not belonging to the initial structure of the complex material used to produce the tubular body, and the covering of the free edges of the multilayer material cut at the end closed by the flat joint, it is possible to restore a protective seal and to isolate the layer of hydrophilic material from a very humid exterior environment.

Advantageously, the strip of impermeable material is fixed by heat sealing. Such fixing is easy and reliable to effect. Furthermore, heat sealing allows partial fusing of the material of the attached strip with the material of an external upper layer of the multilayer complex, thereby improving the seal.

Preferably, the strip of impermeable material is a polyethylene strip. More preferably, care will be taken to ensure that the attached strip of material is made of one and the same material as that of the external layer of the body to which said strip is fixed, or at least of a chemically compatible material for heat sealing.

In order to ensure an optimal seal and covering, it is desirable for the strip of impermeable material to cover at least the entirety of the flat joint zone of the end of the tubular body.

According to one particular embodiment, the tubular body is made from a sheet of multilayer complex wound on itself, said sheet of multilayer complex material having a longitudinal edge-to-edge joint without an overlap. It will be noted that, just like the end cut of the tubular body, the longitudinal edges are also cut and are liable to expose the hydrophilic material directly to the environment. These free edges can be protected from the external environment by any means and in particular by such an edge-to-edge connection without an overlap realized by the Decoseam® method of the company Aisa.

According to one particular embodiment, the hydrophilic material is a cellulose material of the paper or cardboard type, preferably cardboard.

According to one particular embodiment, the multilayer complex material comprises an external layer defining an inner surface of the tubular body that is impermeable at least to water, in particular a polyethylene layer.

In a complementary or alternative manner, the multilayer complex material comprises an external layer defining an outer peripheral surface of the tubular body that is impermeable at least to water, in particular a polyethylene layer.

The multilayer complex material could in particular be a Tetrapak® material.

According to a preferred embodiment, the tubular body has an open end, at the opposite end from the closed end, equipped with a dispensing head. Thus, the packaging and dispensing assembly forms a compressible tube. It should be noted that the attached dispensing head protects the hydrophilic material exposed by a cut of the tube at the opposite end from the end closed by the flat joint.

Preferably, the packaging and dispensing assembly contains a body hygiene cosmetic product, in particular a product of the shower gel or shampoo type.

The present invention also relates to a method for manufacturing a dispensing and packaging assembly according to the present application, said method comprising the steps of:

providing a packaging and dispensing assembly comprising a substantially tubular body obtained from a multilayer complex material, one inner layer of which is made from a hydrophilic material, and having at least one longitudinal end closed by a flat joint between two opposite portions of said tubular body and at which the multilayer material has a free edge directly exposing said layer of hydrophilic material,

applying a strip of impermeable material to a first side of the flat joint along the latter and heat-sealing it to the body on the first side of the flat joint,

folding a portion of the strip of material over a second, opposite side of the flat joint, covering the free edges, and heat-sealing it to the body on the second side of the flat joint.

According to a first embodiment variant, the attached strip of impermeable material has a length substantially equal to the length of the flat joint.

According to a second variant, the attached strip of impermeable material has a length greater than the length of the flat joint, the method comprising an additional step aimed at folding the lateral parts of the strip that protrude beyond the flat joint over a side of the flat joint, the lateral parts being themselves welded to the strip part that has already been welded to the body. The length of the strip of material could for example protrude by 1 to 15 mm on either side of the flat joint.

The invention may be understood better on reading the following description, accompanied by implementation examples thereof, with reference to the appended drawings, in which:

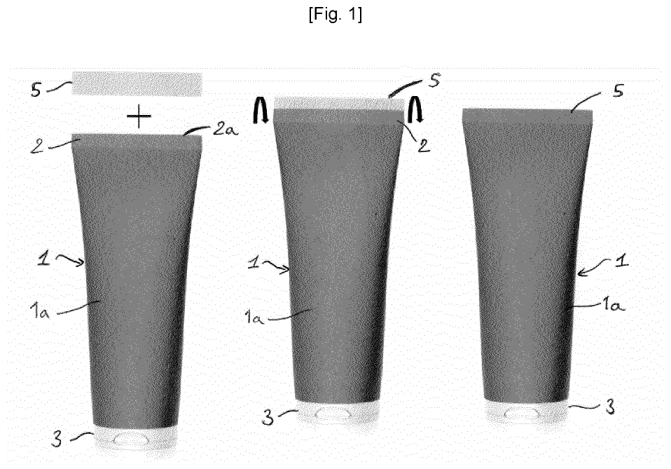

FIG. 1 is a schematic depiction, in longitudinal section, of the steps in a method for manufacturing a packaging and dispensing assembly according to the invention,

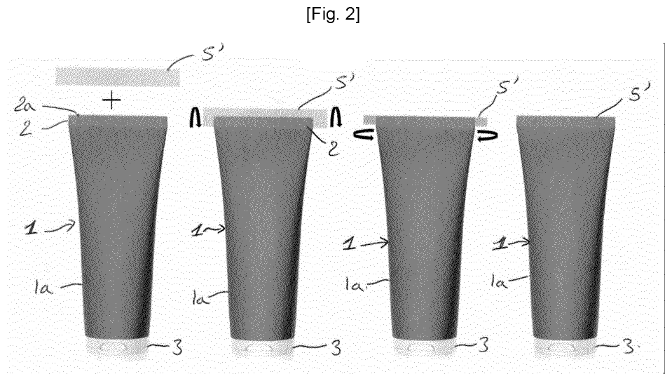

FIG. 2 is a schematic depiction, in longitudinal section, of an embodiment variant of a packaging and dispensing assembly according to the invention.

FIG. 1 shows the steps for producing a packaging and dispensing assembly according to the present application.

The method comprises a first step of providing a packaging and dispensing assembly of the compressible tube 1 type. The compressible tube 1 comprises a substantially tubular body 1a obtained from a multilayer complex material of the Tetrapak® type, one inner layer of which is made from a hydrophilic, cellulose material, in this case cardboard. The multilayer material also comprises a polyethylene upper external layer (forming the outer surface of the tube) and a polyethylene lower external layer (forming the inner surface of the tube).

Conventionally, said tubular body has a first longitudinal end closed by a flat joint 2 between two opposite portions of said tubular body, and a second, opposite open end equipped with a dispensing head 3 made of plastics material. The flat joint is obtained in a known manner by pinching the tube (optionally with crimping) at its end and heating so as to heat-seal the opposite portions of the tubular body that have been pinched together.

According to a usual manufacturing method, the multilayer complex material is cut to the desired tube length and has, at its ends, free edges 2a directly exposing said cardboard layer. While the free edge of the second end is protected by the attached dispensing head, the free edge 2a situated at the end closed by the flat joint 2 is exposed to the ambient humidity.

According to the present application, a strip 5 of impermeable material, in this case a polyethylene strip, is provided, which is intended to be attached to the flat joint so as to cover and protect the free edges. The strip 5 of material has a length substantially equal to the length of the flat joint.

For this purpose, the strip 5 of material is applied to a first side of the flat joint 2 along the latter and is heat-sealed to the body on the first side of the flat joint 2. A portion of the strip of material 5 is then folded over a second, opposite side of the flat joint, covering the free edges, and is heat-sealed to the body on the second side of the flat joint 2.

In this way, the strip of material 5 overlaps the flat joint 2 and covers the free edges 2a, the hydrophilic inner layer then being protected from ambient humidity. Preferably, the strip 5 of impermeable material thus covers the entirety of the flat joint zone 2 of the end of the tubular body 1a.

According to a variant of the method shown in FIG. 2, a strip of material 5′ is attached that has a length greater than the length of the flat joint 2. Consequently, the method comprises an additional step aimed at folding the lateral parts of the strip 5′ that protrude beyond the flat joint over a side of the flat joint 2, the lateral parts being themselves welded to the strip part that has already been welded to the body.

1. A packaging and dispensing assembly comprising a substantially tubular body obtained from a multilayer complex material, at least one inner layer of which is made from a hydrophilic material, said tubular body having at least one longitudinal end closed by a flat joint between two opposite portions of said tubular body and at which the multilayer material has a free edge directly exposing said layer of hydrophilic material, wherein the free edges of the flat joint are covered with a strip of an impermeable material extending on both sides of said flat joint, said strip of impermeable material being fixed in an at least watertight manner to the tubular body along the flat joint.

2. The packaging and dispensing assembly as claimed in claim 1, wherein the strip of impermeable material is fixed by heat sealing.

3. The packaging and dispensing assembly as claimed in claim 1, wherein the strip of impermeable material is a polyethylene strip.

4. The packaging and dispensing assembly as claimed in claim 1, wherein the strip of impermeable material covers at least the entirety of the flat joint zone of the end of the tubular body.

5. The packaging and dispensing assembly as claimed in claim 1, wherein the tubular body is made from a sheet of multilayer complex wound on itself, said sheet of multilayer complex material having a longitudinal edge-to-edge joint without an overlap.

6. The packaging and dispensing assembly as claimed in claim 1, wherein the hydrophilic material is a cellulose material of the paper or cardboard type.

7. The packaging and dispensing assembly as claimed in claim 1, wherein the multilayer complex material comprises an external layer defining an inner surface of the tubular body that is impermeable at least to water, in particular a polyethylene layer.

8. The packaging and dispensing assembly as claimed in claim 1, wherein the multilayer complex material comprises an external layer defining an outer peripheral surface of the tubular body that is impermeable at least to water, in particular a polyethylene layer.

9. The packaging and dispensing assembly as claimed in claim 1, wherein the tubular body has an open end, at the opposite end from the closed end, equipped with a dispensing head.

10. The packaging and dispensing assembly as claimed in claim 1, wherein it contains a body hygiene cosmetic product, in particular a product of the shower gel or shampoo type.

11. A method for manufacturing a packaging and dispensing assembly as claimed in claim 1, wherein it comprises the steps of:
providing a packaging and dispensing assembly comprising a substantially tubular body obtained from a multilayer complex material, at least one inner layer of which is made from a hydrophilic material, and having at least one longitudinal end closed by a flat joint between two opposite portions of said tubular body and at which the multilayer material has a free edge directly exposing said layer of hydrophilic material,
applying a strip of impermeable material to a first side of the flat joint along the latter and heat-sealing it to the body on the first side of the flat joint,
folding a portion of the strip of material over a second, opposite side of the flat joint, covering the free edges, and heat-sealing it to the body on the second side of the flat joint.
